(19) United States
(12) Patent Application Publication
(10) Pub. No.: US 2009/0280376 A1
(43) Pub. Date: Nov. 12, 2009

(54) Solid Oxide Fuel Cell

(76) Inventors: Reiichi Chiba, Kanagawa (JP); Yoshitaka Tabata, Kanagawa (JP); Takeshi Komatu, Kanagawa (JP); Himeko Ohrui, Kanagawa (JP); Kazuhiko Nozawa, Kanagawa (JP); Masayasu Arakawa, Kanagawa (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/084,510

(22) PCT Filed: Nov. 24, 2006
(86) PCT No.: PCT/JP2006/323431

§ 371 Date: Apr. 10, 2009

(30) Foreign Application Priority Data
Nov. 25, 2005 (JP) 2005-340257

(51) Int. Cl. H01M 8/10

(52) U.S. Cl. 429/30

(57) ABSTRACT

A solid oxide fuel cell includes an electrolyte layer (101) made of a sintered product of a metal oxide powder, a fuel electrode (102) formed on one surface of the electrolyte layer (101), and an air electrode (103) formed on the other surface of the electrolyte layer (101) and including an active layer (131) and collector layer (132). The active layer (131) is made of a sintered product of a powder mixture obtained by mixing a powder of a perovskite oxide such as LaNi_{0.6}Fe_{0.4}O₃ (LNF) having an average particle size of 0.5 μm, and a powder of another perovskite oxide such as LNF having an average particle size of 1.3 μm. The collector layer (132) is made of a sintered product of a powder of a perovskite oxide such as LNF having an average particle size of 1.3 μm.

### TECHNICAL FIELD

The present invention relates to a solid oxide fuel cell comprising an electrolyte layer made of an oxide such as ceramic.

### BACKGROUND ART

As a fuel cell that generates electric power by supplying a fuel gas such as hydrogen to a fuel electrode and an oxidizer gas such as air to an air electrode, a solid oxide fuel cell using an oxygen ion conductor as a solid oxide electrolyte layer is recently attracting attention. From the viewpoint of particularly the effective use of energy, the solid oxide fuel cell essentially has a high energy conversion efficiency because it is not restricted by the Carnot efficiency (the limitation of the thermal energy use efficiency). In addition, the solid oxide fuel cell has excellent features, e.g., it is expected to well maintain the environment (reference 1: Hiroaki Tagawa, “Solid Oxide Fuel Cell and Global Environment”, Agune Shofusha, pp. 18-30, 1998).

At the beginning, the operating temperature of the solid oxide fuel cell was as high as 900° C. to 1,000° C., so all members of the cell were made of ceramic. This made it difficult to reduce the manufacturing cost of a cell stack. If it is possible to lower the operating temperature to 800° C. or less, preferably, about 700° C., a heat-resistant alloy material can be used as an interconnector (separator), so the manufacturing cost can be reduced. For example, a perovskite-based metal oxide such as La(Ni—Fe)O₃ having nickel and iron in the B site has a high electrode activity, so the operating temperature can be lowered when this metal oxide is used as the air electrode. As the operating temperature lowers, however, the speed of a chemical reaction at the air electrode decreases, and this abruptly increases the overvoltage as an electrochemical resistance, thereby decreasing the output voltage.

In the solid oxide fuel cell made of the materials as described above, the electrodes and electrolyte layer are each made of a sintered product (ceramic) of fine particles (a powder) of the corresponding material (reference 2: Hiroaki Tagawa, “Solid Oxide Fuel Cell and Global Environment”, Agune Shofusha, pp. 247-278, 1998). Therefore, better electrode characteristics can be obtained by increasing the length of the interface (three-phase boundary (TPB)) of the electrode/electrolyte/gas through which the electrode reaction progresses. Accordingly, the decrease in output voltage caused by the decrease in operating temperature described above can be overcome by increasing the three-phase boundary length.

For example, the air electrode is made of a porous product formed by sintering a powder of a perovskite-based oxide, such as La(Sr)MnO₃ or La(Sr)Fe(Ni)O₃, which has a high electron conductivity and is stable even in a high-temperature oxidizing ambient. When the air electrode is made of a material like this, the three-phase boundary length can be increased by decreasing the particle size of the powder forming the air electrode. This makes it possible to improve the low-temperature characteristics of the air electrode.

On the other hand, the air electrode has the function of supplying the oxidizer gas such as air in addition to supplying an electric current. From the viewpoint of the supply of the gas, therefore, it is favorable to increase the pore size of the porous product to some extent by increasing the particle size.

When the air electrode is made up of a small-particle-size layer on the electrolyte layer side and a large-particle-size layer on the oxidizer gas supply side, it is possible to increase the three-phase boundary length and increase the supply amount of the oxidizer gas at the same time.

### DISCLOSURE OF INVENTION

### Problem to be Solved by the Invention

If the air electrode is made up of two layers having different particle sizes, however, these two layers readily peel off from their interface.

The present invention has been made to solve the above problem, and has as its object to increase the three-phase boundary length while peeling of the layers forming the air electrode is suppressed.

### Means for Solving the Problem

A solid oxide fuel cell according to the present invention comprises at least an electrolyte layer made of a sintered product of a metal oxide powder, a fuel electrode formed on one surface of the electrolyte layer, and an air electrode formed on the other surface of the electrolyte layer and made of a sintered product of a perovskite oxide powder, wherein the air electrode comprises a first layer formed on the electrolyte layer and a second layer formed on the first layer, the first layer is made of a sintered product containing a powder having a small particle size, the second layer is made of a sintered product of a powder having a large particle size larger than the small particle size, and at least a partial region of the first layer, which is in contact with the second layer, is made of a sintered product of a powder mixture of the powder having the small particle size and the powder having the large particle size. This arrangement suppresses large changes in particle size in the interface between the first and second layers. Note that a fuel gas is supplied to the fuel electrode, and an oxidizer gas is supplied to the air electrode.

In the above solid oxide fuel cell, the first layer can entirely be made of the powder mixture. At least a region of the first layer, which is close to the electrolyte layer, can be made of a sintered product of a powder mixture obtained by adding a cerium oxide powder to the perovskite oxide powder. In this case, the particle size of the cerium oxide powder is preferably made smaller than the large particle size. The cerium oxide powder can be obtained by doping a material selected from the group consisting of yttrium oxide, samarium oxide, and gadolinium oxide. The solid oxide fuel cell can further comprise a ceria layer formed between the air electrode and the electrolyte layer, and made of a sintered product of a cerium oxide powder. The cerium oxide powder can be obtained by doping a material selected from the group consisting of yttrium oxide, samarium oxide, and gadolinium oxide in this case as well.

Another solid oxide fuel cell according to the present invention comprises at least an electrolyte layer made of a sintered product of a metal oxide powder, a fuel electrode formed on one surface of the electrolyte layer, and an air electrode formed on the other surface of the electrolyte layer and made of a sintered product of a perovskite oxide powder, wherein the air electrode comprises an active layer formed on a side of the electrolyte layer and a collector layer formed on the active layer, the collector layer is made of a sintered product of a first powder having a first particle size (large particle size), and the active layer is made of a sintered product of a powder mixture containing the first powder and a second powder having a second particle size (small particle size) smaller than the first particle size. This arrangement suppresses large changes in particle size in the interface between the active layer and collector layer.

Still another solid oxide fuel cell according to the present invention comprises at least an electrolyte layer made of a sintered product of a metal oxide powder, a fuel electrode formed on one surface of the electrolyte layer, and an air electrode formed on the other surface of the electrolyte layer and made of a sintered product of a perovskite oxide powder, wherein the air electrode comprises an active layer formed on a side of the electrolyte layer, an interlayer formed on the active layer, and a collector layer formed on the interlayer, the collector layer is made of a sintered product of a first powder having a first particle size (large particle size), the active layer is made of a sintered product of a second powder having a second particle size (small particle size) smaller than the first particle size, and the interlayer is made of a sintered product of a powder mixture of the first powder and the second powder. This arrangement suppresses large changes in particle size in the interface between the active layer and interlayer and in the interface between the interlayer and collector layer.

### EFFECTS OF THE INVENTION

In the present invention as described above, the first layer is made of the sintered product containing the powder having the small particle size, the second layer is made of the sintered product of the powder having the large particle size larger than the small particle size, and at least the partial region of the first layer, which is in contact with the second layer, is made of the sintered product of the powder mixture containing the powder having the small particle size and the powder having the large particle size. This arrangement suppresses large changes in particle size in the interface between the first and second layers, and makes it possible to obtain a remarkable effect of increasing the three-phase boundary length while peeling of the layers forming the air electrode is suppressed.

Also, in the present invention, the active layer is made of the sintered product of the powder mixture containing the first powder having the first particle size and the second powder having the second particle size smaller than the first particle size. This arrangement suppresses large changes in particle size in the interface between the active layer and collector layer, and makes it possible to obtain a notable effect of increasing the three-phase boundary length while peeling of the layers forming the air electrode is suppressed. Furthermore, in the present invention, the interlayer is made of the sintered product of the powder mixture containing the first and second powders. This arrangement suppresses large changes in particle size in the interface between the active layer and interlayer and in the interface between the interlayer and collector layer, and makes it possible to obtain a noteworthy effect of increasing the three-phase boundary length while peeling of the layers forming the air electrode is suppressed.

### BRIEF DESCRIPTION OF DRAWINGS

FIG. 1 is a sectional view showing part of an example of the arrangement of a solid oxide fuel cell according to the first embodiment of the present invention;

FIGS. 2A to 2D are views showing steps of an example of a method of manufacturing the solid oxide fuel cell according to the first embodiment of the present invention;

FIG. 3 is a perspective view showing the arrangement of a manufactured sample;

FIG. 4A is a sectional view showing an example of the arrangement of the solid oxide fuel cell;

FIG. 4B is a perspective view showing an example of the arrangement of part of the solid oxide fuel cell;

FIG. 5 is a sectional view showing part of an example of the arrangement of a solid oxide fuel cell according to the second embodiment of the present invention;

FIGS. 6A to 6E are views showing steps of an example of a method of manufacturing the solid oxide fuel cell according to the second embodiment of the present invention;

FIG. 7 is a sectional view showing part of an example of the arrangement of a solid oxide fuel cell according to the third embodiment of the present invention;

FIG. 8 is a perspective view showing the arrangement of a manufactured sample;

FIG. 9 is a sectional view showing an example of the arrangement of the solid oxide fuel cell; and

FIG. 10 is a sectional view showing part of an example of the arrangement of a solid oxide fuel cell according to the fifth embodiment of the present invention.

### BEST MODE FOR CARRYING OUT THE INVENTION

Embodiments of the present invention will be explained below with reference to the accompanying drawings.

### First Embodiment

The first embodiment of the present invention will be explained first. FIG. 1 is a sectional view showing part of an example of the arrangement of a solid oxide fuel cell according to the first embodiment. The solid oxide fuel cell of the first embodiment comprises an electrolyte layer 101 made of a sintered product of a metal oxide powder, a fuel electrode 102 formed on one surface (the lower surface in FIG. 1) of the electrolyte layer 101, and an air electrode 103 formed on the other surface of the electrolyte layer 101. The air electrode 103 includes an active layer 131 formed on the electrolyte layer 101, and a collector layer 132 formed on the active layer 131.

The electrolyte layer 101 is, e.g., a sintered product (SASZ: 0.89ZrO₂-0.10Sc₂O₃-0.01Al₂O₃) made of a powder of zirconia (ZrO₂) to which Sc₂O₃ and Al₂O₃ are added. The electrolyte layer 101 may also be formed by using sintered products made of powders of oxides such as SSZ ((1-x) (ZrO₂)-x(Sc₂O₃); 0.029≦x≦0.11), YSZ (1-x) (ZrO₂)-x(Y₂O₃); 0.029≦x≦0.11), LSGM (La_{0.8}sr_{0.2}Ga_{0.85}Mg_{0.15}O), LSGMC (La_{0.8}sr_{0.2}Ga_{0.65}Mg_{0.15}Co_{0.2}O) GDC (Ce₁₋ₓGdₓO₂; 0.08≦x≦0.22), SDC (Ce₁₋ₓSmₓO₂; 0.08≦x≦0.22), and YDC (Ce₁₋ₓYₓO₂; 0.08≦x≦0.22). The fuel electrode 102 is, e.g., a sintered product made of a powder mixture formed by mixing a ZrO₂ powder to which Y₂O₃ is added and a nickel oxide powder.

The active layer 131 is, e.g., a sintered product made of a powder mixture formed by mixing a powder (second powder) of a perovskite oxide such as LaNi_{0.6}Fe_{0.4}O₃ (LNF) having an average particle size of 0.5 μm (a small particle size) and a powder (first powder) of a perovskite oxide such as LNF having an average particle size of 1.3 μm (a large particle size). The collector layer 132 is a sintered product made of a powder (first powder) of a perovskite oxide such as LNF having an average particle size of 1.3 μm (a large particle size). These sintered products are porous products having fine pores, and conduct ions (oxygen ions) and electrons in addition to supplying a fuel gas such as hydrogen and an oxidizer gas such as oxygen (air). Accordingly, the air electrode 103 is made of a sintered product of a perovskite oxide powder.

As described above, in the solid oxide fuel cell according to the first embodiment, the air electrode 103 includes the collector layer 132 made of a sintered product of particles (the first powder) having a relatively large particle size (the large particle size, a first particle size), and the active layer 131 made of a sintered product formed by mixing the particles (first powder) forming the collector layer 132 and particles (the small particle size, the second powder) having a particle size smaller than that of the first powder.

In other words, the air electrode 103 is made up of a first layer (the active layer 131) formed on the electrolyte layer 101 and a second layer (the collector layer 132) formed on the first layer, the first layer is made of a sintered product of a powder having the small particle size (second particle size), the second layer is made of a sintered product of a powder having the large particle size (first particle size), and at least a partial region of the first layer, which is in contact with the second layer, is made of a sintered product of a powder mixture of the small-particle-size powder and large-particle-size powder. In the first embodiment, the first layer is entirely made of the powder mixture.

In this arrangement, the three-phase boundary length increases in the active layer 131 in contact with the electrolyte layer 101 because the active layer 131 is made of the electron-conductive powder (second powder) having the small particle size. In the collector layer 132 made of the LNF powder having the large particle size, the pore size of the porous product increases, and this facilitates supplying gases and conducting electrons.

In addition, in the solid oxide fuel cell according to the first embodiment, the LNF powder (first powder) having the large particle size similar to that forming the collector layer 132 is also mixed in the active layer 131. This suppresses large changes in particle size in the interface between the active layer 131 and collector layer 132, thereby eliminating a clear boundary between the active layer 131 and collector layer 132. This makes it possible to suppress concentration of the stress to the interface between the active layer 131 and collector layer 132, and suppress peeling of the active layer 131 and collector layer 132 forming the air electrode 103.

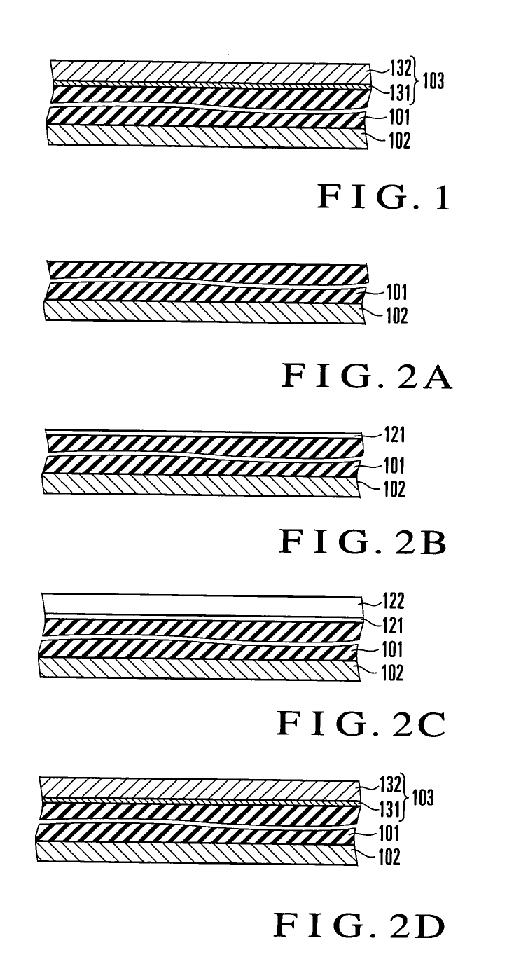

An example of a method of manufacturing the solid oxide fuel cell according to the first embodiment will be explained below. First, as shown in FIG. 2A, a powder of zirconia (a metal oxide) to which Sc₂O₃ and Al₂O₃ are added is dispersed in a predetermined medium to form a slurry, the slurry is shaped by a well-known doctor blade method, and the shaped slurry is sintered to form a 0.2-mm thick electrolyte layer 101. The above powder can be formed by adding Sc₂O₃ and Al₂O₃ to zirconia such that the molar ratio of ZrO₂:Sc₂O₃:Al₂O₃ is 89:10:1.

Then, a slurry formed by mixing 60 wt % of a nickel oxide powder having an average particle size of 0.2 μm to a zirconia powder having an average particle size of 0.6 μm is applied by screen printing and dried, thereby forming a fuel electrode coating film on one surface of the electrolyte paste plate. The zirconia powder can be formed by adding Y₂O₃ to ZrO₂ such that the molar ratio of ZrO₂:Y₂O₃ is 92:8. Subsequently, a metal collector made of a platinum mesh is placed on the formed fuel electrode coating film, and these materials are sintered in air at 1,400° C. for 8 hrs, thereby forming a fuel electrode 102 and a metal collector (not shown in FIG. 2A-2D on one surface (the lower surface in FIG. 2A-2D of the electrolyte layer 101.

A powder mixture formed by mixing an LNF powder having an average particle size of 0.5 μm and an LNF powder having an average particle size of 1.3 μm is dispersed in a medium such as polyethyleneglycol, thereby forming a slurry. The formed slurry is applied on the other surface (the upper surface in FIG. 2A-2D of the electrolyte layer 101 by screen printing and dried, thereby forming an active layer coating film 121 as shown in FIG. 2B.

A slurry is formed by dispersing the LNF powder having an average particle size of 1.3 μm in the medium, and this slurry is applied on the active layer coating film 121 by screen printing and dried, thereby forming a collector layer coating film 122 on the active layer coating film 121 as shown in FIG. 2C. After that, the active layer coating film 121 and collector layer coating film 122 thus formed are sintered at 1,000° C. for 2 hrs, for example, thereby forming an air electrode 103 including an active layer 131 and collector layer 132 on the electrolyte layer 101 as shown in FIG. 2D.

Note that the air electrode 103 is made of LNF in the above description, but the air electrode 103 may also be made of another perovskite oxide. For example, the air electrode 103 may also be made of LCO (LaCoO₃), LSCO (La_{0.8}Sr_{0.2}CoO₃), LSFCO (La_{0.8}Sr_{0.2}Fe_{0.8}CO_{0.2}O₃), or LSF (La_{0.8}Sr_{0.2}FeO₃). Note also that the active layer 131 is made of the sintered product of the powder mixture formed by mixing the LNF powder having an average particle size of 0.5 μm and the LNF powder having an average particle size of 1.3 μm in the above description. However, the active layer 131 need only be made of a sintered product of a powder mixture containing a powder having the same particle size as the particle size (the large particle size, the first particle size) of the powder forming the collector layer 132, and a powder (the second powder) having a particle size (the small particle size, the second particle size) smaller than the first particle size.

The active layer 131 may also be made of a sintered product of a powder mixture formed by adding a powder of Ce_{0.8}Sm_{0.2}O₂ (SDC: a solid solution obtained by doping samarium oxide into ceria) having an average particle size of 0.2 μm to the LNF powder having an average particle size of 0.5 μm and the LNF powder having an average particle size of 1.3 μm. It is also possible to use Ce_{0.8}Y_{0.2}O₂ (YDC: a solid solution obtained by doping yttrium oxide into ceria) or Ce_{0.8}Gd_{0.2}O₂ (GDC: a solid solution obtained by doping gadolinium oxide into ceria) having an average particle size of 0.2 μm, instead of SDC. The particle size of the powder of any of these cerias (cerium oxides) need only be smaller than that of the large-particle-size powder forming the collector layer 132. Note that the large-particle-size powder forming the active layer need only be mixed at a ratio of, e.g., 20 to 80 wt %.

The formation and particle size of each powder will be explained below. For example, the coarse (large-particle-size) powder having an average particle size of 1.3 μm is formed by a well-known, solid-phase reaction method, and milled by a ball mill or the like. This method can form a powder having an average particle size of 0.8 to 1.3 μm. The fine (small-particle-size) powder can be formed by a well-known coprecipitation method. That is, a solution mixture of a solution obtained by dissolving a predetermined amount of desired metal ions or a solution mixture of an organic metal acid salt containing the metal ions is precipitated or gelled by adjusting the temperature and pH, and a powder is obtained by filtering and drying the precipitate or gel. This method can form a powder having an average particle size of 0.01 to 1 μm, although the value changes in accordance with the heating temperature after drying. It is also possible to obtain a powder having an average particle size of 5 μm. Note that the particle size (average particle size) described above is an average particle size obtained by measuring a light intensity distribution pattern by a well-known, laser diffraction scattering method. This similarly applies to particle sizes to be presented below.

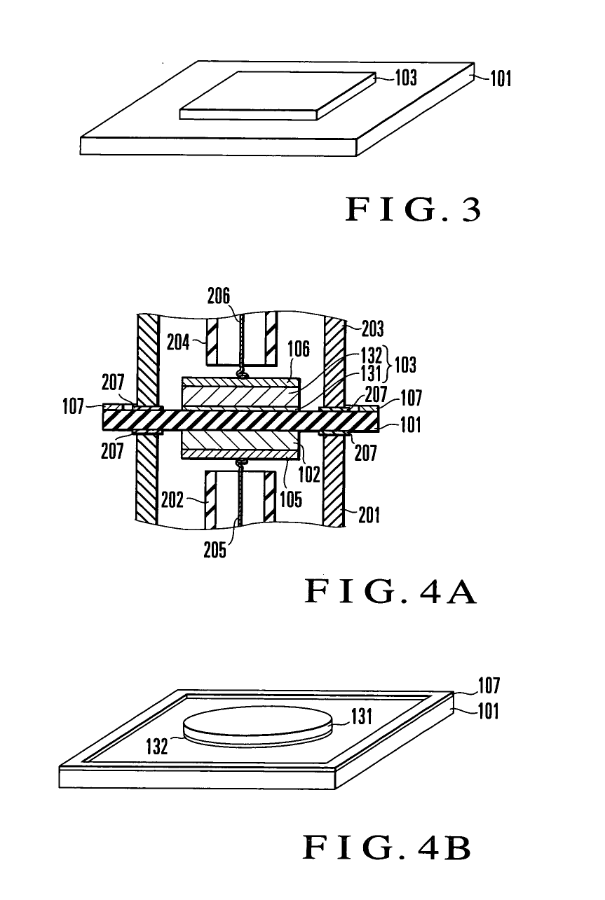

Sample cells were formed by changing the mixing ratio of the powders forming the active layer and the materials forming the active layer, and the adhesion of each sample cell formed was checked. The results of the check and the results of measurements of the interface resistance on the air electrode side will be explained below. First, as shown in FIG. 3, a sample was manufactured by forming an air electrode 103 about 1 cm square on an electrolyte layer 101, and the adhesion was checked by conducting an adhesion test. In this adhesion test, an adhesive tape was adhered on the air electrode 103 of each sample formed, and the residual ratio (residual weight ratio) of the air electrode 103 was measured as the adhesion after the adhered adhesive tape was removed.

In addition, a solid oxide fuel cell as shown in a sectional view of FIG. 4A was manufactured by using each sample cell described above, and the interface resistance on the air electrode side was measured. This solid oxide fuel cell shown in FIG. 4A will be explained below. A fuel electrode 102 and metal collector 105 are stacked on one surface of a 0.2-mm thick electrolyte layer 101, and an air electrode 103 and metal collector 106 are stacked on the other surface. As is also shown in a perspective view of FIG. 4B, a reference electrode 107 made of platinum is formed in the peripheral portion of the other surface of the electrolyte layer 101 on which an active layer 131 and collector layer 132 forming the air electrode are formed.

The end portion of a cylindrical fuel gas exhaust pipe 201 is fixed to one surface of the electrolyte layer 101 so as to surround a region where the fuel electrode 102 is formed. A fuel gas supply pipe 202 is inserted inside the fuel gas exhaust pipe 201. A fuel gas (e.g., hydrogen gas) supplied by the fuel gas supply pipe 202 is supplied to the region of the fuel electrode 102 from the discharge end of the fuel gas supply pipe 202. Also, a gas exhausted from the fuel electrode 102 is extracted outside from a region outside the fuel gas supply pipe 202 in the fuel gas exhaust pipe 201.

On the other hand, the end portion of a cylindrical oxidizer gas exhaust pipe 203 is fixed to the other surface of the electrolyte layer 101 so as to surround a region where the air electrode 103 is formed. An oxidizer gas supply pipe 204 is inserted inside the oxidizer gas exhaust pipe 203. An oxidizer gas (e.g., oxygen gas) supplied by the oxidizer gas supply pipe 204 is supplied to the region of the air electrode 103 from the discharge end of the oxidizer gas supply pipe 204. Also, a gas exhausted from the air electrode 103 is extracted outside from a region outside the oxidizer gas supply pipe 204 in the oxidizer gas exhaust pipe 203. The solid oxide fuel cell generates electric power by thus supplying the fuel gas to the fuel electrode 102 and the oxidizer gas to the air electrode 103. Note that each exhaust pipe is adhered to the surface of the electrolyte layer 101 by a gas seal 207.

Next, the manufactured sample cells and the results of the measurements of the adhesion of each sample and the air electrode interface resistance of each sample cell will be explained with reference to Table 1 below. Note that in Table 1, “Large Particle” indicates the ratio (wt %) of the LNF powder having an average particle size of 1.3 μm mixed when the active layer was formed. Sample number 1-1-0 is a sample obtained by forming the active layer by using only the LNF powder having an average particle size of 0.5 μm. Sample number 1-2-0 is a sample obtained by forming the active layer by using a sintered product of a powder formed by mixing 50 wt % of an SDC (ceria) powder having an average particle size of 0.2 μm to the LNF powder having an average particle size of 0.5 μm. Both the samples are comparative examples obtained by forming the active layer without using a powder (particles) having a large particle size (1.3 μm).

On the other hand, sample numbers 1-2-1 to 1-2-4 are samples each obtained by forming the active layer by mixing a large-particle LNF powder at a weight ratio shown in Table 1 to a powder mixture formed by mixing the ceria powder having an average particle size of 0.2 μm and the LNF powder having an average particle size of 0.5 μm at a ratio of 50:50 (wt %). Sample numbers 1-3-1 to 1-6-1 are samples each obtained by forming the active layer by mixing a large-particle LNF powder at a weight ratio shown in Table 1 to a powder mixture formed by mixing the ceria powder having an average particle size of 0.2 μm and the LNF powder having an average particle size of 0.5 μm at a ratio of 60:40 to 20:80 (wt %).

In Table 1, “Ceria Mixing Amount” indicates the mixing ratio of the small-particle-size LNF powder to the ceria powder, and the mixing amount of the ceria powder in the whole powder used in the formation of the active layer in a sample in which no large particles were mixed. Also, the ratio shown in “Large Particle” of Table 1 indicates the ratio of the large-particle LNF powder to the whole powder used in the formation of the active layer. Furthermore, each number suffixed in “Active Layer” and “Collector Layer” of Table 1 indicates the particle size.

Note that when fuel cells similar to that shown in FIG. 4A were assembled by using the sample cells formed under the conditions shown in Table 1 and a power generation test was conducted at 800° C., a value of 1.14 V was obtained between platinum terminals 205 and 206. Room-temperature humidified (3%) hydrogen was used as the fuel gas, and oxygen was used as the oxidizer gas. Also, while an alternate current was supplied between the fuel electrode 102 and air electrode 103 by using the platinum terminals 205 and 206, the interface resistance component on the air electrode side was separately obtained by measuring the voltage response between the air electrode 103 and reference electrode 107 by using an impedance meter.

The results of the adhesion check described above are as shown in Table 1 below. “Adhesion” of each of sample numbers 1-1-1, 1-1-2, 1-1-3, and 1-1-4 was much higher than that of sample number 1-1-0 as a comparative example. Also, “Adhesion” of each of sample numbers 1-2-1, 1-2-2, 1-2-3, and 1-2-4 was much higher than that of sample number 1-2-0 as a comparative example. It is obvious from the foregoing that the adhesion to the collector layer can be increased by forming the active layer by using the sintered product of the powder mixture formed by mixing the LNF powder having an average particle size of 1.3 μm in the LNF powder having an average particle size of 0.5 μm. The adhesion was a maximum when the mixing amount of the LNF powder having an average particle size of 1.3 μm was 60 wt %. Note that there was no difference in interface resistance on the air electrode side between the comparative examples and samples. Note also that as shown in Table 1, the interface resistance on the air electrode side can be decreased by adding SDC to the active layer.

TABLE 1

| Sample | | Ceria Mixing |
|---|---|---|
| No. | Active Layer | Amount* |
| 1-1-0 | LNF 0.5 | None |
| 1-1-1 | LNF 0.5 + LNF 1.3 | None |
| 1-1-2 | LNF 0.5 + LNF 1.3 | None |
| 1-1-3 | LNF 0.5 + LNF 1.3 | None |
| 1-1-4 | LNF 0.5 + LNF 1.3 | None |
| 1-2-0 | LNF 0.5 + SDC 0.2 | None |
| 1-2-1 | LNF 0.5 + SDC 0.2 + LNF 1.3 | SDC 50% |
| 1-2-2 | LNF 0.5 + SDC 0.2 + LNF 1.3 | SDC 50% |
| 1-2-3 | LNF 0.5 + SDC 0.2 + LNF 1.3 | SDC 50% |
| 1-2-4 | LNF 0.5 + SDC 0.2 + LNF 1.3 | SDC 50% |
| 1-3-0 | LNF 0.5 + SDC 0.2 | SDC 60% |
| 1-4-0 | LNF 0.5 + SDC 0.2 | SDC 40% |
| 1-5-0 | LNF 0.5 + SDC 0.2 | SDC 30% |
| 1-6-0 | LNF 0.5 + SDC 0.2 | SDC 20% |
| 1-3-1 | LNF 0.5 + SDC 0.2 + LNF 1.3 | SDC 60% |
| 1-4-1 | LNF 0.5 + SDC 0.2 + LNF 1.3 | SDC 40% |
| 1-5-1 | LNF 0.5 + SDC 0.2 + LNF 1.3 | SDC 30% |
| 1-6-1 | LNF 0.5 + SDC 0.2 + LNF 1.3 | SDC 20% |

| Sample | Large | Collector | | Interface |
|---|---|---|---|---|
| No. | Particle | Layer | Adhesion | Resistance |
| 1-1-0 | None | LNF 1.3 | 35% | 3.0 Ω |
| 1-1-1 | 20 wt % | LNF 1.3 | 68% | 3.1 Ω |
| 1-1-2 | 40 wt % | LNF 1.3 | 90% | 2.9 Ω |
| 1-1-3 | 60 wt % | LNF 1.3 | 95% | 3.0 Ω |
| 1-1-4 | 80 wt % | LNF 1.3 | 81% | 3.3 Ω |
| 1-2-0 | None | LNF 1.3 | 15% | 1.4 Ω |
| 1-2-1 | 20 wt % | LNF 1.3 | 55% | 1.3 Ω |
| 1-2-2 | 40 wt % | LNF 1.3 | 76% | 1.2 Ω |
| 1-2-3 | 60 wt % | LNF 1.3 | 80% | 1.4 Ω |
| 1-2-4 | 80 wt % | LNF 1.3 | 48% | 1.6 Ω |
| 1-3-0 | None | LNF 1.3 | 28% | 1.5 Ω |
| 1-4-0 | None | LNF 1.3 | 15% | 1.3 Ω |
| 1-5-0 | None | LNF 1.3 | 25% | 1.4 Ω |
| 1-6-0 | None | LNF 1.3 | 30% | 1.8 Ω |
| 1-3-1 | 60 wt % | LNF 1.3 | 88% | 1.4 Ω |
| 1-4-1 | 60 wt % | LNF 1.3 | 82% | 1.3 Ω |
| 1-5-1 | 60 wt % | LNF 1.3 | 83% | 1.3 Ω |
| 1-6-1 | 60 wt % | LNF 1.3 | 80% | 1.7 Ω |

*The ceria mixing amount indicates the mixing ratio (wt %) of the small-particle-size LNF powder to the ceria powder, and the mixing amount of the ceria powder in the whole powder used in the formation of the active layer in a sample in which no large particles were mixed.

### Second Embodiment

A solid oxide fuel cell according to the second embodiment of the present invention will be explained below. FIG. 5 is a sectional view showing part of an example of the arrangement of another solid oxide fuel cell according to the second embodiment of the present invention. The solid oxide fuel cell of the second embodiment comprises an electrolyte layer 101 made of a sintered product of a metal oxide powder, a fuel electrode 102 formed on one surface (the lower surface in FIG. 5) of the electrolyte layer 101, and an air electrode 503 formed on the other surface of the electrolyte layer 101. The air electrode 503 includes an active layer 531 formed on the electrolyte layer 101, an interlayer 533 formed on the active layer 531, and a collector layer 532 formed on the interlayer 533. The interlayer 533 is inserted between the active layer 531 and collector layer 532.

The electrolyte layer 101 is, e.g., a sintered product (SASZ: 0.89ZrO₂-0.10Sc₂O₃-0.01Al₂O₃) made of a powder of zirconia (ZrO₂) to which Sc₂O₃ and Al₂O₃ are added. The fuel electrode 102 is, e.g., a sintered product made of a powder mixture formed by mixing a ZrO₂ powder to which Y₂O₃ is added and a nickel oxide powder. The active layer 531 is, e.g., a sintered product made of an LaNi_{0.6}Fe_{0.4}O₃ (LNF) powder having an average particle size of 0.5 μm. The collector layer 532 is a sintered product made of an LNF powder having an average particle size of 1.3 μm. The interlayer 533 is a sintered product made of a powder mixture obtained by mixing the LNF powder having an average particle size of 0.5 μm and the LNF powder having an average particle size of 1.3 μm. These sintered products are porous products having fine pores, and conduct ions (oxygen ions) and electrons in addition to supplying a fuel gas such as hydrogen and an oxidizer gas such as oxygen (air).

As described above, in the solid oxide fuel cell according to the second embodiment, the air electrode 503 includes the collector layer 532 made of the sintered product of the LNF particles (a first powder) having a relatively large particle size, the interlayer 533 made of the sintered product formed by mixing the LNF particles (first powder) forming the collector layer 532 and the LNF particles (a second powder) having a particle size smaller than that of the first powder, and the active layer 531 made of the sintered product of the LNF particles (second powder) having a particle size smaller than that of the LNF particles forming the collector layer 532.

In other words, the air electrode 503 is made up of a first layer formed on the electrolyte layer 101 and a second layer (the collector layer 532) formed on the first layer, the first layer is made of a sintered product containing a powder having a small particle size (second particle size), the second layer is made of a sintered product of a powder having a large particle size (first particle size) larger than the small particle size, and at least a partial region (the interlayer 533) of the first layer, which is in contact with the second layer, is made of a sintered product of a powder mixture of the small-particle-size powder and large-particle-size powder. In the second embodiment, the first layer includes the interlayer 533 made of the sintered product of the powder mixture, and the active layer 531 made of the sintered product of the powder having the small particle size (second particle size).

Consequently, the three-phase boundary length increases in the active layer 531 in contact with the electrolyte layer 101 because the active layer 531 is made of the electron-conductive powder (second powder) having the small particle size. In the collector layer 532 made of the LNF powder (first powder) having the large particle size, the pore size of the porous product increases, and this facilitates supplying gases and conducting electrons.

In addition, the interlayer 533 is formed in the solid oxide fuel cell according to the second embodiment. This suppresses large changes in particle size in the interface between the active layer 531 and interlayer 533 and in the interface between the interlayer 533 and collector layer 532, thereby eliminating a clear boundary between them. This makes it possible to suppress concentration of the stress to the interfaces between the active layer 531 and interlayer 533 and between the interlayer 533 and collector layer 532, and suppress peeling of these layers forming the air electrode 503.

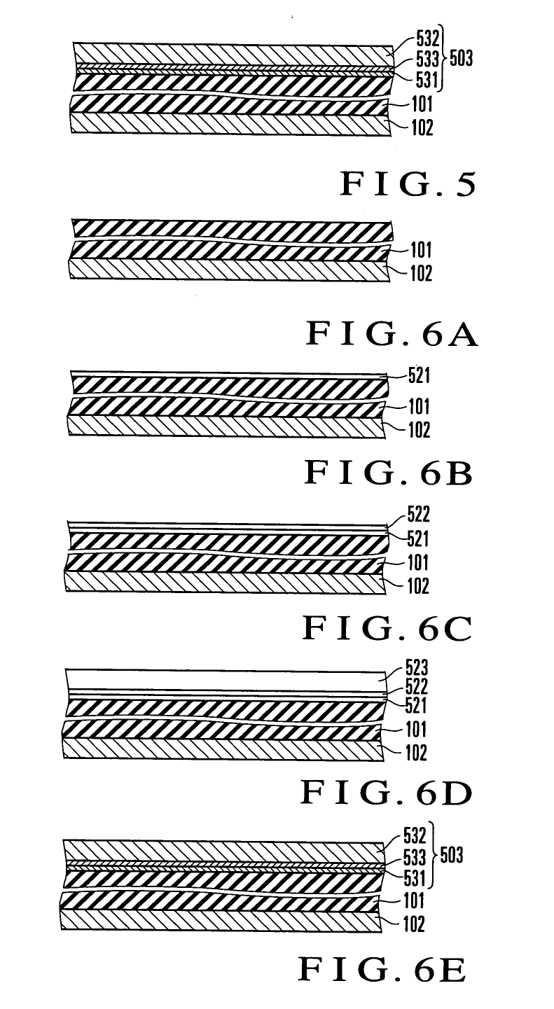

An example of a method of manufacturing the solid oxide fuel cell according to the second embodiment will be explained below. First, as shown in FIG. 6A, a powder of zirconia (a metal oxide) to which Sc₂O₃ and Al₂O₃ are added is dispersed in a predetermined medium to form a slurry, the slurry is shaped by a well-known doctor blade method, and the shaped slurry is sintered to form a 0.2-mm thick electrolyte layer 101. The above powder can be formed by adding Sc₂O₃ and Al₂O₃ to zirconia such that the molar ratio of ZrO₂:Sc₂O₃:Al₂O₃ is 89:10:1.

Then, a slurry formed by mixing 60 wt % of a nickel oxide powder having an average particle size of 0.2 μm to a zirconia powder having an average particle size of 0.6 μm is applied by screen printing and dried, thereby forming a fuel electrode coating film on one surface of the electrolyte paste plate. The zirconia powder can be formed by adding Y₂O₃ to ZrO₂ such that the molar ratio of ZrO₂:Y₂O₃ is 92:8. Subsequently, a metal collector made of a platinum mesh is placed on the formed fuel electrode coating film, and these materials are sintered in air at 1,400° C. for 8 hrs, thereby forming a fuel electrode 102 and a metal collector (not shown in FIG. 6A-6E on one surface (the lower surface in FIG. 6A-6E of the electrolyte layer 101.

A slurry is formed by dispersing an LNF powder having an average particle size of 0.5 μm in a medium such as polyethyleneglycol. The formed slurry is applied on the other surface (the upper surface in FIG. 6A-6E of the electrolyte layer 101 by screen printing and dried, thereby forming an active layer coating film 521 as shown in FIG. 6B. A slurry is formed by dispersing, in the same medium as above, a powder mixture formed by mixing the LNF powder having an average particle size of 0.5 μm and an LNF powder having an average particle size of 1.3 μm. The formed slurry is applied on the active layer coating film 521 by screen printing and dried, thereby forming an interlayer coating film 522 as shown in FIG. 6C.

A slurry is formed by dispersing the LNF powder having an average particle size of 1.3 μm in the medium, and this slurry is applied on the interlayer coating film 522 by screen printing and dried, thereby forming a collector layer coating film 523 on the interlayer coating film 522 as shown in FIG. 6D. After that, the active layer coating film 521, interlayer coating film 522, and collector layer coating film 523 thus formed are sintered at 1,000° C. for 2 hrs, for example, thereby forming an air electrode 503 including an active layer 531, interlayer 533, and collector layer 532 on the electrolyte layer 101 as shown in FIG. 6E.

Note that the air electrode 503 is made of LNF in the above description, but the air electrode 503 may also be made of another perovskite oxide. Note also that the interlayer 533 is made of the sintered product of the powder mixture formed by mixing the powder having an average particle size of 0.5 μm and the powder having an average particle size of 1.3 μm in the above description, but the interlayer 533 need only be made of a sintered product of a powder mixture formed by mixing a powder having the same particle size as the particle size (the large particle size, the first particle size) of the powder forming the collector layer 532, and a powder having the same particle size as the particle size (the small particle size, the second particle size) of the powder forming the active layer 531.

The active layer 531 is made of the sintered product of the LaNi_{0.6}Fe_{0.4}O₃ (LNF) powder having an average particle size of 0.5 μm. However, the material of the active layer 531 is not limited to this. The active layer 531 may also be made of a sintered product of a powder mixture formed by adding a powder of Ce_{0.8}Y_{0.2}O₂ (YDC) having an average particle size of 0.2 μm to the LNF powder having an average particle size of 0.5 μm. Furthermore, it is also possible to use Ce_{0.8}Sm_{0.2}O₂ (SDC) having an average particle size of 0.2 μm, instead of YDC. The particle size of the powder of any of these cerias (cerium oxides) need only be smaller than that of the large-particle-size powder forming the collector layer 532. Note that the large-particle-size powder forming the interlayer 533 need only be mixed at a ratio of, e.g., 30 to 70 wt %.

Sample cells were formed by changing the mixing ratio of the powders forming the active layer and the materials forming the active layer, and the adhesion of each sample cell formed was checked. The results of the check and the results of measurements of the interface resistance on the air electrode side will be explained below. First, a sample was manufactured by forming an air electrode 503 about 1 cm square on an electrolyte layer 101, and the adhesion was checked by conducting an adhesion test. This sample was obtained by replacing the air electrode 103 of the sample shown in FIG. 3 with the air electrode 503 of the second embodiment shown in FIG. 5. In this adhesion test, an adhesive tape was adhered on the air electrode 503 of each sample formed, and the residual ratio (residual weight ratio) of the air electrode 503 was measured as the adhesion after the adhered adhesive tape was removed. In addition, a solid oxide fuel cell as shown in a sectional view of FIG. 4A was manufactured by using each sample cell described above, and the interface resistance on the air electrode side was measured. Note that the air electrode 503 of the second embodiment shown in FIG. 5 was used instead of the air electrode 103 shown in FIG. 4A.

Next, the manufactured sample cells and the results of the measurements of the adhesion of each sample and the air electrode interface resistance of each sample cell will be explained with reference to Table 2 below. Note that in Table 2, the field of “Interlayer” indicates the ratio (wt %) of the LNF powder having an average particle size of 1.3 μm mixed when the interlayer was formed. Sample number 1-1-0 is a sample having no interlayer. Sample number 2-2-0 is a sample having no interlayer and obtained by forming the active layer by using a sintered product of a powder formed by mixing 50 wt % of a YDC powder having an average particle size of 0.2 μm to the LNF powder having an average particle size of 0.5 μm. Both the samples are comparative examples having no interlayer. Sample numbers 2-2-1 to 2-2-3 are samples in each of which large particles were mixed in the interlayer while the mixing ratio of LNF having a particle size of 0.5 μm as a small particle size to YDC having a particle size of 0.2 μm as a small particle size was held at 50:50 (wt %). In Table 2, each number suffixed in “Active Layer” and “Collector Layer” indicates the particle size.

Note that when fuel cells similar to that shown in FIG. 4A were assembled by using the sample cells formed under the conditions shown in Table 2 and a power generation test was conducted at 800° C., a value of 1.14 V was obtained between platinum terminals 205 and 206. Electric power is generated when a fuel gas is supplied to the fuel electrode 102 and an oxidizer gas is supplied to the air electrode 503 in the solid oxide fuel cell of the second embodiment as well. Room-temperature humidified (3%) hydrogen was used as the fuel gas, and oxygen was used as the oxidizer gas. Also, while an alternate current was supplied between the fuel electrode 102 and air electrode 503 (neither is shown in FIG. 3) by using the platinum terminals 205 and 206, the interface resistance component on the air electrode side was separately obtained by measuring the voltage response between the air electrode 503 and a reference electrode 107 by using an impedance meter.

The results of the adhesion check described above are as shown in Table 2 below. “Adhesion” of each of sample numbers 2-1-1, 2-1-2, and 2-1-3 was much higher than that of sample number 1-1-0 as a comparative example. Also, “Adhesion” of each of sample numbers 2-2-1, 2-2-2, and 2-2-3 was much higher than that of sample number 2-2-0 as a comparative example. It is obvious from the foregoing that the adhesion between the individual layers can be increased by using the interlayer made of the powder mixture formed by mixing the LNF powder having an average particle size of 1.3 μm in the LNF powder having an average particle size of 0.5 μm. Note that there was no difference in interface resistance on the air electrode side between the comparative examples and samples. Note also that as shown in Table 2, the interface resistance on the air electrode side can be decreased by adding YDC to the active layer.

TABLE 2

| Sample | | Large Particle in |
|---|---|---|
| No. | Active Layer | Interlayer |
| 1-1-0 | LNF 0.5 | None |
| 2-1-1 | LNF 0.5 + LNF 1.3 | 30 wt % |
| 2-1-2 | LNF 0.5 + LNF 1.3 | 50 wt % |
| 2-1-3 | LNF 0.5 + LNF 1.3 | 70 wt % |
| 2-2-0 | LNF 0.5 + YDC 0.2 | None |
| 2-2-1 | LNF 0.5 + YDC 0.2 | 30 wt % |
| 2-2-2 | LNF 0.5 + YDC 0.2 | 50 wt % |
| 2-2-3 | LNF 0.5 + YDC 0.2 | 70 wt % |

| Sample | Large Particle | Collector | | Interface |
|---|---|---|---|---|
| No. | in Interlayer | Layer | Adhesion | Resistance |
| 1-1-0 | None | LNF 1.3 | 35% | 3.0 Ω |
| 2-1-1 | 30 wt % | LNF 1.3 | 63% | 2.9 Ω |
| 2-1-2 | 50 wt % | LNF 1.3 | 78% | 2.9 Ω |
| 2-1-3 | 70 wt % | LNF 1.3 | 89% | 3.1 Ω |
| 2-2-0 | None | LNF 1.3 | 15% | 1.4 Ω |
| 2-2-1 | 30 wt % | LNF 1.3 | 83% | 1.4 Ω |
| 2-2-2 | 50 wt % | LNF 1.3 | 90% | 1.3 Ω |
| 2-2-3 | 70 wt % | LNF 1.3 | 82% | 1.4 Ω |

### Third Embodiment

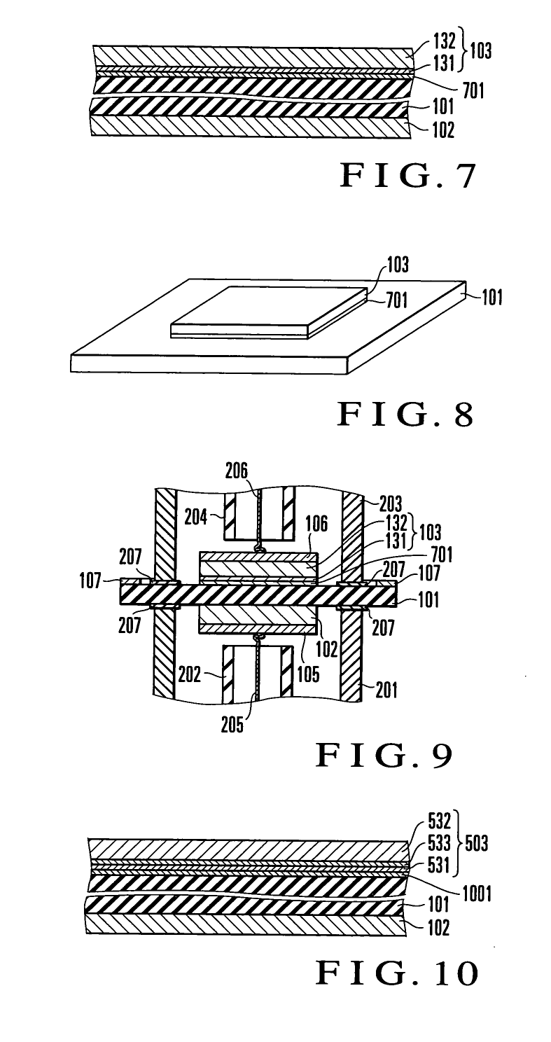

The third embodiment of the present invention will be explained below. FIG. 7 is a sectional view showing part of an example of the arrangement of a solid oxide fuel cell according to the third embodiment of the present invention. The solid oxide fuel cell of the third embodiment comprises an electrolyte layer 101 made of a sintered product of a metal oxide powder, a fuel electrode 102 formed on one surface (the lower surface in FIG. 7) of the electrolyte layer 101, and an air electrode 103 formed on the other surface of the electrolyte layer 101. The air electrode 103 includes an active layer 131 formed on the electrolyte layer 101, and a collector layer 132 formed on the active layer 131. The foregoing are the same as in the solid oxide fuel cell of the first embodiment.

In the solid oxide fuel cell according to the third embodiment, a ceria layer 701 made of a sintered product of a cerium oxide powder is additionally formed on the electrolyte layer 101, and the air electrode 103 (active layer 131) is formed on the ceria layer 701. The ceria layer 701 need only be made of any of SDC (a solid solution obtained by doping samarium oxide into cerium oxide), YDC (a solid solution obtained by doping yttrium oxide into cerium oxide), and GDC (a solid solution obtained by doping gadolinium oxide into cerium oxide). The ceria layer 701 can suppress the increase in resistance between the electrolyte layer 101 and air electrode 103.

An example of a method of manufacturing the solid oxide fuel cell according to the third embodiment will be explained below. First, in the same manner as in the manufacture of the solid oxide fuel cell of the first embodiment, an electrolyte layer 101 is formed, and a fuel electrode 102, metal collector, and the like are formed on one surface of the electrolyte layer 101. Then, a slurry is formed by dispersing a slurry made of a Ce_{0.9}Gd_{0.1}O₂ powder having an average particle size of 0.1 μm in a medium such as polyethyleneglycol. This slurry is applied on the other surface of the electrolyte layer 101 by screen printing and dried, thereby forming a ceria layer coating film.

Subsequently, an active layer coating film and collector layer coating film are formed on the ceria layer coating film as in the solid oxide fuel cell of the first embodiment. In the third embodiment, the active layer coating film is made of an LNF powder that is a mixture of powders having average particle sizes of 0.4 and 1.0 μm, and the collector layer coating film is made of an LNF powder having an average particle size of 1.0 μm. These films are sintered at 1,0000° C. for 2 hrs, for example, thereby forming a ceria layer 701 on the electrolyte layer 101, and forming an air electrode 103 including an active layer 131 and collector layer 132 on the ceria layer 701, as shown in FIG. 7.

Sample cells were formed by changing the mixing ratio of the powders forming the active layer 131 and the materials forming the active layer 131, and the adhesion of each sample cell formed was checked. The results of the check and the results of measurements of the interface resistance on the air electrode side will be explained below. First, as shown in FIG. 8, a sample was manufactured by forming a ceria layer 701 and air electrode 103 about 1 cm square on an electrolyte layer 101, and the adhesion was checked by conducting an adhesion test. In this adhesion test, an adhesive tape was adhered on the air electrode 103 of each sample formed, and the residual ratio (residual weight ratio) of the air electrode 103 was measured as the adhesion after the adhered adhesive tape was removed.

In addition, a solid oxide fuel cell as shown in a sectional view of FIG. 9 was manufactured by using each sample cell described above, and the interface resistance on the air electrode side was measured. This solid oxide fuel cell shown in FIG. 9 will be explained below. A fuel electrode 102 and metal collector 105 are stacked on one surface of a 0.2-mm thick electrolyte layer 101, and a ceria layer 701, air electrode 103, and metal collector 106 are stacked on the other surface. Also, a reference electrode 107 made of platinum is formed in the peripheral portion of the other surface of the electrolyte layer 101.

The end portion of a cylindrical fuel gas exhaust pipe 201 is fixed to one surface of the electrolyte layer 101 so as to surround a region where the fuel electrode 102 is formed. A fuel gas supply pipe 202 is inserted inside the fuel gas exhaust pipe 201. A fuel gas (e.g., hydrogen gas) supplied by the fuel gas supply pipe 202 is supplied to the region of the fuel electrode 102 from the discharge end of the fuel gas supply pipe 202. Also, a gas exhausted from the fuel electrode 102 is extracted outside from a region outside the fuel gas supply pipe 202 in the fuel gas exhaust pipe 201.

On the other hand, the end portion of a cylindrical oxidizer gas exhaust pipe 203 is fixed to the other surface of the electrolyte layer 101 so as to surround a region where the ceria layer 701 and air electrode 103 are formed. An oxidizer gas supply pipe 204 is inserted inside the oxidizer gas exhaust pipe 203. An oxidizer gas (e.g., oxygen gas) supplied by the oxidizer gas supply pipe 204 is supplied to the region of the air electrode 103 from the discharge end of the oxidizer gas supply pipe 204. Also, a gas exhausted from the air electrode 103 is extracted outside from a region outside the oxidizer gas supply pipe 204 in the oxidizer gas exhaust pipe 203. The solid oxide fuel cell generates electric power by thus supplying the fuel gas to the fuel electrode 102 and the oxidizer gas to the air electrode 103. Note that each exhaust pipe is adhered to the surface of the electrolyte layer 101 by a gas seal 207.

Next, the manufactured sample cells and the results of the measurements of the adhesion of each sample and the air electrode interface resistance of each sample cell will be explained with reference to Table 3 below. Note that in Table 3, “Large Particle” indicates the ratio (wt %) of an LNF powder having an average particle size of 1 μm mixed when the active layer was formed. Sample number 3-1-0 is a sample formed by using only an LNF powder having an average particle size of 0.4 μm. Sample number 3-2-0 is a sample obtained by forming the active layer by using a sintered product of a powder formed by mixing 50 wt % of a GDC (ceria) powder having an average particle size of 0.1 μm to the LNF powder having an average particle size of 0.4 μm. Both the samples are comparative examples obtained by forming the active layer without using a powder (particles) having a large particle size (1.0 μm).

On the other hand, sample numbers 3-2-1 to 3-2-4 are samples each obtained by forming the active layer by mixing a large-particle LNF powder at a weight ratio shown in Table 3 to a powder mixture formed by mixing a ceria powder having an average particle size of 0.2 μm and the LNF powder having an average particle size of 0.4 μm at a ratio of 50:50 (wt %). Sample numbers 3-3-1 to 3-6-1 are samples each obtained by forming the active layer by mixing a large-particle LNF powder at a weight ratio shown in Table 3 to a powder mixture formed by mixing the ceria powder having an average particle size of 0.2 μm and the LNF powder having an average particle size of 0.4 μm at a ratio of 60:40 to 20:80 (wt %).

In Table 3, “Ceria Mixing Amount” indicates the mixing ratio of the small-particle-size LNF powder to the ceria powder, and the mixing amount of the ceria powder in the whole powder used in the formation of the active layer in a sample in which no large particles were mixed. Also, the ratio shown in “Large Particle” of Table 3 indicates the ratio of the large-particle LNF powder to the whole powder used in the formation of the active layer. Furthermore, each number suffixed in “Active Layer” and “Collector Layer” of Table 3 indicates the particle size.

Note that when fuel cells similar to that shown in FIG. 9 were assembled by using the sample cells formed under the conditions shown in Table 3 and a power generation test was conducted at 800° C., a value of 1.14 V was obtained between platinum terminals 205 and 206. Room-temperature humidified (3%) hydrogen was used as the fuel gas, and oxygen was used as the oxidizer gas. Also, while an alternate current was supplied between the fuel electrode 102 and air electrode 103 by using the platinum terminals 205 and 206, the interface resistance component on the air electrode side was separately obtained by measuring the voltage response between the air electrode 103 and reference electrode 107 by using an impedance meter. Note that “Interface Resistance” in Table 3 is the resistance between the electrolyte layer 101 and air electrode 103 when the ceria layer 701 was inserted.

The results of the adhesion check described above are as shown in Table 3 below. “Adhesion” of each of sample numbers 3-1-1, 3-1-2, 3-1-3, and 3-1-4 was much higher than that of sample number 3-1-0 as a comparative example. Also, “Adhesion” of each of sample numbers 3-2-1, 3-2-2, 3-2-3, and 3-2-4 was much higher than that of sample number 3-2-0 as a comparative example. It is obvious from the foregoing that the adhesion to the collector layer can be increased by adding the ceria layer 701 and forming the active layer by using the sintered product of the powder mixture formed by mixing the LNF powder having a larger average particle size of 1.0 μm than the 0.4-μm LNF powder in the LNF powder having an average particle size of 0.4 μm, as in the solid oxide fuel cell of the first embodiment.

Also, in the solid oxide fuel cell of the third embodiment, the values of the resistance between the electrolyte layer 101 and air electrode 103 are lower than those shown in Table 1 because the ceria layer 701 is formed. When forming the ceria layer 701, the adhesion can be further increased by adding the same GDC as that of the ceria layer 701 to the active layer 103 containing a certain amount of large particles, as indicated by samples 3-2-2 to 3-2-4. Note that there was no difference in interface resistance on the air electrode side between the comparative examples and samples. Note also that as shown in Table 3, the interface resistance on the air electrode side decreased when GDC was added to the active layer.

TABLE 3

| Sample | | Ceria Mixing |
|---|---|---|
| No. | Active Layer | Amount* |
| 3-1-0 | LNF 0.4 | None |
| 3-1-1 | LNF 0.4 + LNF 1.0 | None |
| 3-1-2 | LNF 0.4 + LNF 1.0 | None |
| 3-1-3 | LNF 0.4 + LNF 1.0 | None |
| 3-1-4 | LNF 0.4 + LNF 1.0 | None |
| 3-2-0 | LNF 0.4 + GDC 0.1 | None |
| 3-2-1 | LNF 0.4 + GDC 0.1 + LNF 1.0 | GDC 50% |
| 3-2-2 | LNF 0.4 + GDC 0.1 + LNF 1.0 | GDC 50% |
| 3-2-3 | LNF 0.4 + GDC 0.1 + LNF 1.0 | GDC 50% |
| 3-2-4 | LNF 0.4 + GDC 0.1 + LNF 1.0 | GDC 50% |
| 3-3-0 | LNF 0.4 + GDC 0.1 | GDC 60% |
| 3-4-0 | LNF 0.4 + GDC 0.1 | GDC 40% |
| 3-5-0 | LNF 0.4 + GDC 0.1 | GDC 30% |
| 3-6-0 | LNF 0.4 + GDC 0.1 | GDC 20% |
| 3-3-1 | LNF 0.4 + GDC 0.2 + LNF 1.0 | GDC 60% |
| 3-4-1 | LNF 0.4 + GDC 0.2 + LNF 1.0 | GDC 40% |
| 3-5-1 | LNF 0.4 + GDC 0.2 + LNF 1.0 | GDC 30% |
| 3-6-1 | LNF 0.4 + GDC 0.2 + LNF 1.0 | GDC 20% |

| Sample | Large | Collector | | Interface |
|---|---|---|---|---|
| No. | Particle | Layer | Adhesion | Resistance |
| 3-1-0 | None | LNF 1.0 | 21% | 2.2 Ω |
| 3-1-1 | 20 wt % | LNF 1.0 | 39% | 2.2 Ω |
| 3-1-2 | 40 wt % | LNF 1.0 | 75% | 2.1 Ω |
| 3-1-3 | 60 wt % | LNF 1.0 | 90% | 1.9 Ω |
| 3-1-4 | 80 wt % | LNF 1.0 | 95% | 1.8 Ω |
| 3-2-0 | None | LNF 1.0 | 35% | 1.2 Ω |
| 3-2-1 | 20 wt % | LNF 1.0 | 65% | 1.2 Ω |
| 3-2-2 | 40 wt % | LNF 1.0 | 88% | 1.1 Ω |
| 3-2-3 | 60 wt % | LNF 1.0 | 95% | 0.9 Ω |
| 3-2-4 | 80 wt % | LNF 1.0 | 99% | 1.2 Ω |
| 3-3-0 | None | LNF 1.0 | 45% | 1.3 Ω |
| 3-4-0 | None | LNF 1.0 | 37% | 1.1 Ω |
| 3-5-0 | None | LNF 1.0 | 33% | 1.1 Ω |
| 3-6-0 | None | LNF 1.0 | 27% | 1.6 Ω |
| 3-3-1 | 60 wt % | LNF 1.0 | 99% | 1.1 Ω |
| 3-4-1 | 60 wt % | LNF 1.0 | 95% | 0.8 Ω |
| 3-5-1 | 60 wt % | LNF 1.0 | 93% | 0.9 Ω |
| 3-6-1 | 60 wt % | LNF 1.0 | 88% | 1.0 Ω |

*The ceria mixing amount indicates the mixing ratio (wt %) of the small-particle-size LNF powder to the ceria powder, and the mixing amount of the ceria powder with respect to the whole powder used in the formation of the active layer in a sample in which no large particles were mixed.

### Fourth Embodiment

Sample cells were formed by changing the mixing ratio of the powders forming the active layer and the materials forming the active layer by using the materials described above, and the adhesion of each sample cell formed was checked. The results of the check and the results of measurements of the interface resistance on the air electrode side will be explained below. First, as in the third embodiment described above, a sample was manufactured by forming a ceria layer 701 and air electrode 103 about 1 cm square on an electrolyte layer 101, and the adhesion was checked by conducting an adhesion test.

Next, the manufactured sample cells and the results of the measurements of the adhesion of each sample and the air electrode interface resistance of each sample cell will be explained with reference to Table 4 below. In Table 4, a number suffixed to each material indicates the particle size. Sample number 4-1-0 is a sample obtained by forming the active layer by using only an LCO powder having an average particle size of 0.6 μm. Sample number 4-2-0 is a sample obtained by forming the active layer by using only an LSCO powder having an average particle size of 0.6 μm. Sample number 4-3-0 is a sample obtained by forming the active layer by using only an LSFCO powder having an average particle size of 0.6 μm. Sample number 4-4-0 is a sample obtained by forming the active layer by using only an LSF powder having an average particle size of 0.4 μm. These samples are comparative examples each obtained by forming the active layer without using any large-particle-size powder (particles).

Sample number 4-1-2 is a sample obtained by forming the active layer by using a sintered product of a powder formed by mixing 50 wt % of a GDC (ceria) powder having an average particle size of 0.1 μm in an LCO powder having an average particle size of 0.6 μm. Sample number 4-2-2 is a sample obtained by forming the active layer by using a sintered product of a powder formed by mixing 50 wt % of the ceria powder having an average particle size of 0.1 μm in an LSCO powder having an average particle size of 0.6 μm. Sample number 4-3-2 is a sample obtained by forming the active layer by using a sintered product of a powder formed by mixing 50 wt % of the ceria powder having an average particle size of 0.1 μm in an LSFCO powder having an average particle size of 0.6 μm. Sample number 4-4-2 is a sample obtained by forming the active layer by using a sintered product of a powder formed by mixing 50 wt % of the ceria powder having an average particle size of 0.1 μm in an LSF powder having an average particle size of 0.4 μm. These samples are also comparative examples each obtained by forming the active layer without using any powder (particles).

On the other hand, sample numbers 4-1-3 to 4-4-3 are samples each obtained by forming the active layer by mixing a large-particle powder at a weight ratio shown in Table 4 below in a powder mixture formed by mixing the ceria (GDC) powder having an average particle size of 0.1 μm and a small-particle powder at a ratio of 50:50 (wt %). In Table 4, each number suffixed in “Active Layer” and “Collector Layer” indicates the particle size.

First, when fuel cells similar to that shown in FIG. 9 were assembled by using the sample cells formed under the conditions shown in Table 4 and a power generation test was conducted at 800° C., a value of 1.14 V was obtained between platinum terminals 205 and 206. Electric power was generated when a fuel gas was supplied to the fuel electrode 102 and an oxidizer gas was supplied to the air electrode 103 in the solid oxide fuel cell of the fourth embodiment as well.

Room-temperature humidified (3%) hydrogen was used as the fuel gas, and oxygen was used as the oxidizer gas. Also, while an alternate current was supplied between the fuel electrode 102 and air electrode 103 by using the platinum terminals 205 and 206, the interface resistance component on the air electrode side was separately obtained by measuring the voltage response between the air electrode 103 and reference electrode 107 by using an impedance meter. Note that “Interface Resistance” in Table 4 is the resistance between the electrolyte layer 101 and air electrode 103 when the ceria layer 701 was inserted.

The results of the adhesion check described above are as shown in Table 4 below. “Adhesion” of each of sample numbers 4-1-1 to 4-4-3 was much higher than those of sample numbers 4-1-0 to 4-4-0 as comparative examples. It is obvious from the foregoing that the adhesion can be increased by forming the active layer 103 by mixing a large-particle-size powder in a small-particle-size powder regardless of the materials used. Note that there was no difference in interface resistance on the air electrode side between the comparative examples and samples.

Also, the ceria layer 701 is formed in the solid oxide fuel cell of the fourth embodiment as well. Therefore, the values of the resistance between the electrolyte layer 101 and air electrode 103 are lower than those shown in Table 1. When forming the ceria layer 701, it is possible to increase the adhesion and reduce the resistance on the air electrode side by adding the same GDC as that of the ceria layer 701.

TABLE 4

| Sample | |
|---|---|
| No. | Active Layer |
| 4-1-0 | LCD 0.6 |
| 4-2-0 | LSCO 0.6 |
| 4-3-0 | LSFCO 0.6 |
| 4-4-0 | LSF 0.4 |
| 4-1-1 | LCO 0.6 + LCO 1.0 |
| 4-2-1 | LSCO 0.6 + LSCO 1.3 |
| 4-3-1 | LSFCO 0.6+ LSFCO 1.0 |
| 4-4-1 | LSF 0.4 + LSF 1.0 |
| 4-1-2 | LCO 0.6 + GDC 0.1 |
| 4-2-2 | LSCO 0.6 + GDC 0.1 |
| 4-3-2 | LSFCO 0.6 + GDC 0.1 |
| 4-4-2 | LSF 0.4 + GDC 0.1 |
| 4-1-3 | LCO 0.4 + GDC 0.1 + LCO 1.0 |
| 4-2-3 | LSCO 0.4 + GDC 0.1 + LSCO 1.0 |
| 4-3-3 | LSFCO 0.6 + GDC 0.1 + LSFCO 1.0 |
| 4-4-3 | LSF 0.4 + GDC 0.1 + LSF 1.0 |

| Sample | Large | Collector | | Interface |
|---|---|---|---|---|
| No. | Particle* | Layer | Adhesion | Resistance |
| 4-1-0 | None | LCD 1.0 | 25% | 2.6 Ω |
| 4-2-0 | None | LSCO 1.3 | 31% | 2.1 Ω |
| 4-3-0 | None | LSFCO 1.0 | 48% | 2.9 Ω |
| 4-4-0 | None | LSF 1.0 | 54% | 3.3 Ω |
| 4-1-1 | 70 wt % | LCD 1.0 | 74% | 2.5 Ω |
| 4-2-1 | 70 wt % | LSCO 1.3 | 82% | 2.2 Ω |
| 4-3-1 | 70 wt % | LSFCO 1.0 | 88% | 3.2 Ω |
| 4-4-1 | 70 wt % | LSF 1.0 | 92% | 3.2 Ω |
| 4-1-2 | None | LCO 1.0 | 81% | 1.4 Ω |
| 4-2-2 | None | LSCO 1.3 | 85% | 1.1 Ω |
| 4-3-2 | None | LSFCO 1.0 | 89% | 1.8 Ω |
| 4-4-2 | None | LSF 1.0 | 93% | 2.3 Ω |
| 4-1-3 | 70 wt % | LCO 1.0 | 95% | 1.1 Ω |
| 4-2-3 | 70 wt % | LSCO 1.3 | 97% | 1.0 Ω |
| 4-3-3 | 70 wt % | LSFCO 1.0 | 98% | 1.6 Ω |
| 4-4-3 | 70 wt % | LSF 1.0 | 99% | 1.8 Ω |

*The large particle indicates the ratio (wt %) of large particles added to a powder mixture obtained by mixing a ceria powder and small-particle powder at a ratio of 50:50 (wt %).

### Fifth Embodiment

The fifth embodiment of the present invention will be explained below. FIG. 10 is a sectional view showing part of an example of the arrangement of a solid oxide fuel cell according to the fifth embodiment of the present invention. The solid oxide fuel cell of the fifth embodiment comprises an electrolyte layer 101 made of a sintered product of a metal oxide powder, a fuel electrode 102 formed on one surface (the lower surface in FIG. 10) of the electrolyte layer 101, and an air electrode 503 formed on the other surface of the electrolyte layer 101. The air electrode 503 includes an active layer 531 formed on the electrolyte layer 101, an interlayer 533 formed on the active layer 531, and a collector layer 532 formed on the interlayer 533. The interlayer 533 is inserted between the active layer 531 and collector layer 532.

The foregoing are almost the same as the solid oxide fuel cell of the second embodiment. In the solid oxide fuel cell according to the fifth embodiment, a ceria layer 1001 made of a sintered product of a cerium oxide powder is additionally formed on the electrolyte layer 101, and the air electrode 503 (active layer 531) is formed on the ceria layer 1001. The ceria layer 1001 need only be made of SDC, YDC, or GDC. As in the third embodiment described previously, the ceria layer 1001 can suppress the increase in resistance between the electrolyte layer 101 and air electrode 503.

Note that the large particle sizes (first particle sizes) are 1.3 and 1.0 μm in the above description, but the sizes are not limited to these and the range of the large particle size is preferably 0.7 to 5.0 μm, and more preferably, 0.8 to 1.5 μm. Note also that the small particle sizes (second particle sizes) are 0.4 and 0.6 μm in the above description, but the sizes are not limited to these and the range of the small particle size is preferably 0.01 to 0.6 μm, and more preferably, 0.05 to 0.5 μm.

### INDUSTRIAL APPLICABILITY

The present invention is preferably used as a solid oxide fuel cell.

1. A solid oxide fuel cell characterized by comprising at least:
an electrolyte layer made of a sintered product of a metal oxide powder;
a fuel electrode formed on one surface of said electrolyte layer; and
an air electrode formed on the other surface of said electrolyte layer and made of a sintered product of a perovskite oxide powder,
wherein said air electrode comprises a first layer formed on said electrolyte layer and a second layer formed on said first layer,
said first layer is made of a sintered product containing a powder having a small particle size,
said second layer is made of a sintered product of a powder having a large particle size larger than the small particle size, and
at least a partial region of said first layer, which is in contact with said second layer, is made of a sintered product of a powder mixture of the powder having the small particle size and the powder having the large particle size.

2. A solid oxide fuel cell according to claim 1, characterized in that said first layer is entirely made of the powder mixture.

3. A solid oxide fuel cell according to claim 1, characterized in that at least a region of said first layer, which is close to said electrolyte layer, is made of a sintered product of a powder mixture obtained by adding a cerium oxide powder to the perovskite oxide powder.

4. A solid oxide fuel cell according to claim 3, characterized in that a particle size of the cerium oxide powder is made smaller than the large particle size.

5. A solid oxide fuel cell according to claim 3, characterized in that the cerium oxide powder is obtained by doping a material selected from the group consisting of yttrium oxide, samarium oxide, and gadolinium oxide.

6. A solid oxide fuel cell according to claim 3, characterized by further comprising a ceria layer formed between said air electrode and said electrolyte layer, and made of a sintered product of a cerium oxide powder.

7. A solid oxide fuel cell according to claim 6, characterized in that the cerium oxide powder is obtained by doping a material selected from the group consisting of yttrium oxide, samarium oxide, and gadolinium oxide.

8. A solid oxide fuel cell characterized by comprising at least:
an electrolyte layer made of a sintered product of a metal oxide powder;
a fuel electrode formed on one surface of said electrolyte layer; and
an air electrode formed on the other surface of said electrolyte layer and made of a sintered product of a perovskite oxide powder,
wherein said air electrode comprises an active layer formed on a side of said electrolyte layer and a collector layer formed on said active layer,
said collector layer is made of a sintered product of a first powder having a first particle size, and
said active layer is made of a sintered product of a powder mixture containing the first powder and a second powder having a second particle size smaller than the first particle size.

9. A solid oxide fuel cell characterized by comprising at least:
an electrolyte layer made of a sintered product of a metal oxide powder;
a fuel electrode formed on one surface of said electrolyte layer; and
an air electrode formed on the other surface of said electrolyte layer and made of a sintered product of a perovskite oxide powder,
wherein said air electrode comprises an active layer formed on a side of said electrolyte layer, an interlayer formed on said active layer, and a collector layer formed on said interlayer,
said collector layer is made of a sintered product of a first powder having a first particle size,
said active layer is made of a sintered product of a second powder having a second particle size smaller than the first particle size, and
said interlayer is made of a sintered product of a powder mixture of the first powder and the second powder.

10. A solid oxide fuel cell according to claim 1, characterized in that
a fuel gas is supplied to said fuel electrode, and an oxidizer gas is supplied to said air electrode.
